(19) United States
(12) Patent Application Publication
(10) Pub. No.: US 2024/0413363 A1
(43) Pub. Date: Dec. 12, 2024

(54) METHOD FOR CONDITIONING AN ELECTROCHEMICAL CELL UNIT

(71) Applicant: Robert Bosch GmbH, Stuttgart (DE)

(72) Inventors: Anton Ringel, Bamberg (DE); Juergen Hackenberg, Sachsenheim (DE); Julia Drillkens, Bamberg (DE); Michael Giuseppe Marino, Asperg (DE)

(21) Appl. No.: 18/709,844

(22) PCT Filed: Sep. 27, 2022
(86) PCT No.: PCT/EP2022/076830

§ 371 Date: May 14, 2024

(30) Foreign Application Priority Data
Nov. 23, 2021 (DE) 10 2021 213 139.5

(51) Int. Cl. H01M 8/04225; C25B 9/75; C25B 9/77; C25B 11/032; C25B 11/036; C25B 15/08; H01M 8/10; H01M 8/241; H01M 8/2465

(52) U.S. Cl. CPC H01M 8/04225; C25B 9/75; C25B 9/77; C25B 11/032; C25B 11/036; C25B 15/085; H01M 8/241; H01M 8/2465; H01M 2008/1095

(57) ABSTRACT

Method for conditioning an electrochemical cell unit (53) before putting the electrochemical cell unit (53) into operation for converting electrochemical energy into electrical energy as a fuel cell unit (1) and/or for converting electrical energy into electrochemical energy as an electrolytic cell unit (49) having stacked electrochemical cells (52) and channels for conducting a fuel and/or an electrolyte and channels for conducting an oxidizing agent and/or an electrolyte being formed in the electrochemical cell unit (53), the method having the steps of: providing a conditioning fluid; and conducting the conditioning fluid through the channels (12) for fuel and/or electrolytes and/or conducting the conditioning fluid through the channels (13) for oxidizing agents and/or electrolytes, wherein, during at least 50% of the duration of the method for conditioning the electrochemical cell unit (53), hydrogen is conducted as the conditioning fluid through the channels (13) for oxidizing agents and/or electrolytes.

### BACKGROUND

The present invention relates to a method for conditioning an electrochemical cell unit and an electrochemical cell unit.

Fuel cell units as galvanic cells convert continuously supplied fuel and oxidizing agent into electrical energy and water by means of redox reactions at an anode and cathode. Fuel cells are used in a wide variety of stationary and mobile applications, for example in houses without a connection to the electricity grid or in motor vehicles, rail transport, aviation, space travel and shipping. In fuel cell units, a large number of fuel cells are arranged in a stack.

In fuel cell units, a large number of fuel cells are arranged in a fuel cell stack. Inside each fuel cell there is a gas chamber for oxidizing agents, i.e. a flow chamber for conducting oxidizing agents, such as air from the surroundings with oxygen. The gas chamber for oxidizing agents is formed by channels on the bipolar plate and by a gas diffusion layer for a cathode. The channels are thus formed by a corresponding channel structure of a bipolar plate and the oxidizing agent, namely oxygen, reaches the cathode of the fuel cells through the gas diffusion layer. Similarly, there is a gas chamber for fuel.

Electrolysis cell units consisting of stacked electrolysis cells, similar to fuel cell units, are used for the electrolytic production of hydrogen and oxygen from water, for example. Furthermore, fuel cell units are known which can be operated as reversible fuel cell units and thus as electrolysis cell units. Fuel cell units and electrolysis cell units form electrochemical cell units. Fuel cells and electrolysis cells form electrochemical cells.

During the production of a fuel cell unit, individual fuel cells are stacked to form a stack as the fuel cell unit. The components of the fuel cells include anodes, cathodes and proton exchange membranes. The components of the fuel cells, in particular the electrodes and/or the catalyst layers, have oxide layers and impurities. Fuel cell components, in particular proton exchange membranes, have a low moisture or water content after the fuel cells have been arranged in the stack. As a result, the proton exchange membranes in particular would have a low proton conductivity and, in addition, high ohmic and electrical losses would occur at the anodes and cathodes. The oxide layers and impurities adversely reduce the performance of the fuel cell unit. To avoid this, it is necessary to condition the fuel cell unit as the stack with a conditioning fluid as a conditioning gas. During conditioning, also known as “pre-conditioning” or “break-in”, of the fuel cell unit, a humidified gas, generally air, is passed through the channels for fuel and oxidizing agent so that hydration of these components with water or moisture from the conditioning gas is achieved. The conditioning method also removes the oxide layers and impurities. In addition, it is already known to operate the fuel cell unit for conditioning purposes, i.e. to convert electrochemical energy into electrical energy by feeding fuel to the anode through the fuel channels and oxidizing agent to the cathodes through the oxidizing agent channels. This operation of the fuel cell unit is generally carried out in different, alternating load states, in particular with very high and very low outputs of the fuel cell unit. This results in a high consumption of hydrogen as a fuel, so that high costs for conditioning are a disadvantageous consequence.

Due to the physical and chemical processes during the conditioning method, it is necessary to conduct the conditioning gas as a conditioning fluid through the channels for fuel and oxidizing agent over a long period of several hours until impurities and oxide layers, in particular on the electrodes and/or catalyst layers, are removed and a sufficient water content of the components anodes, cathodes and proton exchange membrane is present, i.e. hydration of these components with water or moisture from the conditioning gas is achieved. If a large number of fuel cell units are produced industrially in several hours, large storage rooms are therefore required to hold the fuel cell units produced in several hours for the conditioning process. This results in disadvantageously high costs for the production of the fuel cell units, because correspondingly large storage rooms have to be provided and a large number of devices are also required to carry out the method for simultaneous conditioning of the large number of fuel cell units. Similarly, conditioning is also necessary for electrolytic cell units.

DE 10 2013 101 829 A1 shows a method for retracting and moistening membrane electrode assemblies (MEAs) in a fuel cell stack, wherein the method comprises: performing voltage cycling and humidification of the MEAs in the fuel cell stack with one or more temperature steps, wherein the current density of the stack is cycled within a predetermined range for each of the one or more temperature steps; maintaining a fuel cell stack voltage within a predetermined range and maintaining anode and cathode reactant fluxes at an approximate set point while cycling the current density in the one or more temperature steps to run-in and humidify the MEAs in the stack so that the stack can be operated at a predetermined threshold for a fuel cell stack output voltage capability.

DE 10 2015 225 507 A1 shows a method for accelerating the activation of a fuel cell stack, in which a process for applying a high current to the fuel cell stack for a fixed period of time and a shutdown maintenance process for pumping hydrogen to an air electrode reaction surface for a fixed period of time are repeated several times. The process for applying the high current to the fuel cell stack and the shutdown maintenance process for pumping the hydrogen to the air electrode reaction surface are performed for 3 to 5 seconds in an initial stage of fuel cell stack activation and then for 65 to 75 seconds by gradually extending the time in a later stage of fuel cell stack activation. The shutdown maintenance process comprises the following: a process for cutting off the oxygen supply to an air electrode and supplying the hydrogen to a fuel electrode in a shutdown state of the fuel cell stack; a reaction process (H₂→2H⁺+2e⁻) in which the hydrogen is dissociated into hydrogen cations and electrons in the fuel electrode; and a reaction process (2H[g3]+[/g3]+2e⁻→H₂) in which the dissociated hydrogen cations and electrons are passed to the air electrode through an electrolyte membrane and reconnected to the electrons.

US 2016/0336612 A1 shows a method for accelerating the activation of a fuel cell stack.

### SUMMARY

Method according to the invention for conditioning an electrochemical cell unit before commissioning the electrochemical cell unit for converting electrochemical energy into electrical energy as a fuel cell unit and/or for converting electrical energy into electrochemical energy as an electrolysis cell unit with stacked electrochemical cells and channels for conducting a fuel and/or an electrolyte and channels for conducting an oxidizing agent and/or an electrolyte are formed in the electrochemical cell unit, comprising the steps of providing a conditioning fluid, passing and/or flooding the conditioning fluid through and/or into the channels for fuel and/or electrolyte and/or passing and/or flooding the conditioning fluid through the channels for oxidizing agent and/or electrolyte, wherein hydrogen is passed as conditioning fluid through the channels for oxidizing agent and/or electrolyte during at least 50% of the duration of the method for conditioning the electrochemical cell unit. Hydrogen as a reducing agent enables an effective reduction of oxide layers and impurities, in particular by reducing metal oxides to metal using the reducing agent hydrogen.

In a complementary embodiment, hydrogen is passed through the oxidant and/or electrolyte channels for at least 70%, 80% or 90% of the time of the electrochemical cell unit conditioning method.

In a further variant, hydrogen is passed through the channels for oxidizing agents and/or electrolytes during the entire duration of the method for conditioning the electrochemical cell unit.

In an additional embodiment, during the passage of hydrogen through the oxidant and/or electrolyte channels, the anodes and cathodes are connected to a DC current source so that a DC voltage difference is formed between the anodes and cathodes. Due to the DC voltage difference between the anodes and cathodes on the electrochemical cells, especially fuel cells, hydrogen is oxidized to protons at the anodes, releasing electrons, and protons are reduced to hydrogen at the cathodes, accepting electrons.

Preferably, protons migrate through the proton exchange membranes in one direction from the anodes to the cathodes during the passage of hydrogen through the channels for oxidizing agents and/or electrolytes.

In a supplementary embodiment, while hydrogen is being passed through the channels for oxidizing agent and/or electrolyte, hydrogen is simultaneously passed through the channels for fuel and/or electrolyte as a conditioning fluid. While the method is being carried out, the hydrogen is thus passed simultaneously through the channels and/or gas chambers for fuel and/or electrolytes and through the channels and/or gas chambers for oxidizing agent and/or electrolytes. This means that only one conditioning fluid, namely hydrogen gas, is advantageously required for conditioning the electrochemical cell unit. The method can therefore be carried out in a simple, inexpensive and reliable manner.

In a further configuration, during the passage of hydrogen through the channels for fuel and/or electrolytes, protons are formed from the hydrogen at the anodes by reducing the hydrogen to protons while releasing electrons and these protons migrate through the proton exchange membranes in one direction from the anodes to the cathodes.

In an additional embodiment, the amount and/or mass fraction of hydrogen in the conditioning fluid passing through the channels for oxidizing agent and/or electrolyte and/or through the channels for fuel and/or electrolyte is at least 80%, 90%, 95%, 98% or 99%. The amount of hydrogen and/or mass fraction of hydrogen in the conditioning fluid is generally slightly less than 100% because water and/or water vapor in the conditioning fluid is necessary to humidify components of the fuel cells.

Conveniently, during the passage of hydrogen through the channels for oxidizing agent and/or electrolyte, the channels and/or gas chambers for fuel and/or electrolyte are simultaneously flooded with water as a conditioning fluid.

In a further variant, protons are formed from the water at the anodes during the flooding of the channels for fuel and/or electrolytes with water and these protons migrate through the proton exchange membranes in one direction from the anodes to the cathodes. To carry out the method, a DC voltage is applied to the anodes and cathodes so that hydrogen is formed from the water at the anodes by electrolysis and this hydrogen formed at the anodes is then also oxidized to protons at the anodes, releasing electrons, and these protons migrate through the proton exchange membranes.

In an additional embodiment, hydrogen is formed at the cathodes during the passage of hydrogen through the channels for oxidizing agents and/or electrolytes by reducing the protons that have migrated through the proton exchange membrane to hydrogen by accepting electrons from the cathodes.

In a supplementary variant, the hydrogen is passed through the channels and/or gas chambers for oxidizing agent and/or electrolyte and/or through the channels gas chambers for fuel and/or electrolyte with a, in particular common, circuit.

In an additional configuration, the hydrogen is moistened and/or enriched with water and/or water vapor before being introduced into the channels for oxidants and/or electrolytes and/or into the channels for fuel and/or electrolytes.

In particular, the method, especially the passing of hydrogen through the channels for oxidizing agents and/or electrolytes, is carried out during a period of between 5 min and 3 h, in particular between 10 min and 2 h, preferably continuously.

Electrochemical cell unit according to the invention for converting electrochemical energy into electrical energy as a fuel cell unit and/or for converting electrical energy into electrochemical energy as an electrolysis cell unit, comprising stacked electrochemical cells and the electrochemical cells each comprise stacked layered components and the components of the electrochemical cells are proton exchange membranes, anodes, cathodes, preferably gas diffusion layers and bipolar plates, wherein a method described in this application for industrial property rights can be carried out with the electrochemical cell unit.

In an additional embodiment, the amount and/or mass fraction of water and/or water vapor in the conditioning fluid is between 0% and 15%, in particular between 0% and 5%.

In an additional embodiment, the sum of the mass fraction and/or mass fraction of hydrogen and water and/or water vapor in the conditioning fluid is at least 95%, 98%, 99%, 99.5% or 99.9%, in particular 100%.

In a further embodiment, adhesion and/or hydration and/or hydration of water and/or moisture to components of the electrochemical cell unit originating from the hydrogen conditioning fluid is performed during the execution of the method.

In a further variant, hydrogen is fed through the channels and/or gas chambers for fuel and/or through the channels and/or gas chambers for oxidizing agents.

The channels and/or gas chambers for fuel are suitably flooded with water.

In a further variant, the channels for fuel and/or electrolytes are flooded with water by passing water through the channels for fuel and/or electrolytes or by arranging them without flow.

In a further embodiment, the poles of the direct current source are reversed during the method, in particular several times, so that the anodes before the polarity reversal become cathodes after the polarity reversal and the cathodes before the polarity reversal become anodes after the polarity reversal and vice versa.

In a further variant, the method is carried out during a deactive state of the electrochemical cell unit as a manufacturing process.

In a supplementary variant, the temperature of the conditioning fluid is detected by a sensor and, depending on the detected temperature of the conditioning fluid, heating and/or cooling is controlled and/or regulated so that the temperature of the conditioning fluid substantially corresponds, in particular with a deviation of less than 30%, 20% or 10%, to a set temperature value. The setpoint as a specific temperature is, for example, between 3° C. and 70° C., in particular between 15° C. and 25° C.

In a further variant, the method described in this property right application is carried out with an electrochemical cell unit described in this property right application.

In a supplementary variant, the method for conditioning described in this property right application is a manufacturing step of a method for manufacturing an electrochemical cell unit, wherein preferably before the method for conditioning, the electrochemical cells are made available and the electrochemical cells are stacked to form the electrochemical cell unit as a cell stack.

The invention further comprises a computer program comprising program code means stored on a computer-readable data carrier for carrying out a method described in this patent application when the computer program is executed on a computer or a corresponding computing unit.

The invention also includes a computer program product comprising program code means stored on a computer-readable data carrier for carrying out a method described in this application for industrial property rights when the computer program is executed on a computer or a corresponding computing unit.

The bipolar plates are conveniently designed as separator plates and an electrical insulation layer, in particular a proton exchange membrane, is arranged between each anode and each cathode.

Fuel cell system according to the invention, in particular for a motor vehicle, comprising a fuel cell unit as a fuel cell stack with fuel cells, a compressed gas reservoir for storing gaseous fuel, a gas conveying device for conveying a gaseous oxidizing agent to the cathodes of the fuel cells, wherein the fuel cell unit is designed as a fuel cell unit and/or electrolysis cell unit described in this application for industrial property rights.

Electrolysis system and/or fuel cell system according to the invention, comprising an electrolysis cell unit as an electrolysis cell stack with electrolysis cells, preferably a compressed gas reservoir for storing gaseous fuel, preferably a gas conveying device for conveying a gaseous oxidizing agent to the cathodes of the fuel cells, a storage reservoir for liquid electrolyte, a pump for conveying the liquid electrolyte, wherein the electrolysis cell unit is designed as an electrolysis cell unit and/or fuel cell unit described in this property right application.

In a further configuration, the electrochemical cells, in particular fuel cells and/or electrolysis cells, each preferably comprise an insulating layer, in particular a proton exchange membrane, an anode, a cathode, preferably at least one gas diffusion layer and at least one bipolar plate, in particular at least one separator plate.

Preferably, the fuel is hydrogen, hydrogen-rich gas, reformate gas, or natural gas.

The fuel cells and/or electrolysis cells are essentially flat and/or disk-shaped.

In a supplementary variant, the oxidizing agent is air, comprising oxygen or pure oxygen.

Preferably, the fuel cell unit is a PEM fuel cell unit with PEM fuel cells or an alkaline fuel cell (AFC).

### BRIEF DESCRIPTION OF THE DRAWINGS

In the following, exemplary embodiments of the invention are described in more detail with reference to the accompanying drawings. The following is shown in the figures:

FIG. 1 a highly simplified exploded view of an electrochemical cell system as a fuel cell system and electrolysis cell system with components of an electrochemical cell as a fuel cell and electrolysis cell,

FIG. 2 a perspective view of part of a fuel cell and electrolysis cell,

FIG. 3 a longitudinal section through electrochemical cells as fuel cells and electrolysis cells,

FIG. 4 a perspective view of an electrochemical cell unit as a fuel cell unit and electrolysis cell unit as a fuel cell stack and electrolysis cell stack,

FIG. 5 a side view of the electrochemical cell unit as a fuel cell unit and electrolysis cell unit as a fuel cell stack and electrolysis cell stack,

FIG. 6 a perspective view of a bipolar plate and

FIG. 7 highly simplified illustration of an electrochemical cell unit with a device for carrying out a conditioning method.

### DETAILED DESCRIPTION

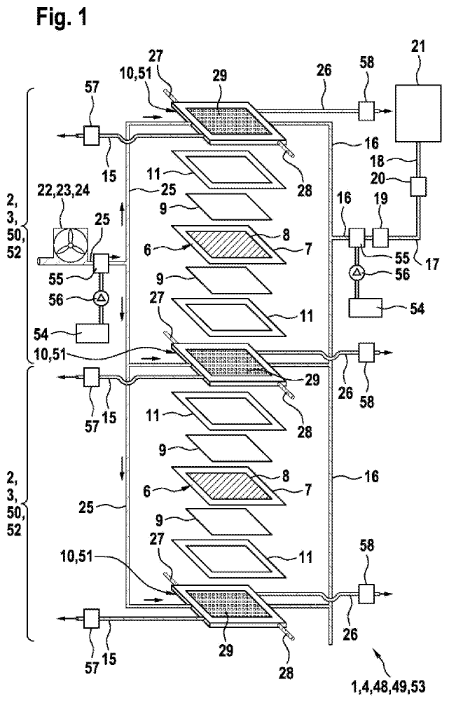

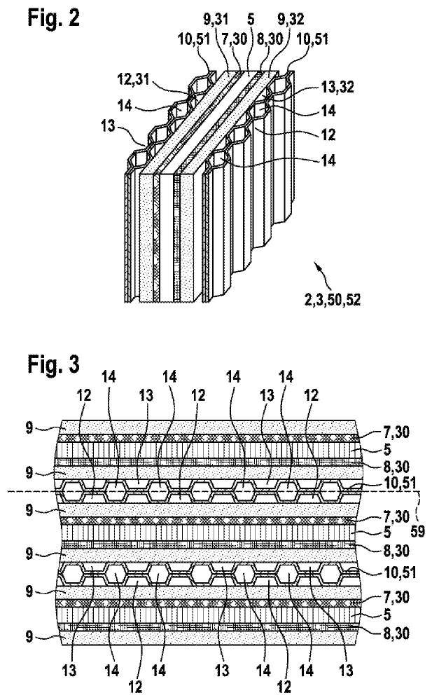

In FIGS. 1 through 3, the basic construction of a fuel cell 2 is shown as a PEM fuel cell 3 (polymer electrolyte fuel cell 3). The principle of fuel cells 2 is that electrical energy or electrical current is generated by means of an electrochemical reaction. Hydrogen H₂ is conducted to an anode 7 as a gaseous fuel, and the anode 7 forms the negative pole. A gaseous oxidant, i.e., air with oxygen, is conducted to a cathode 8, i.e., the oxygen in the air provides the necessary gaseous oxidant. A reduction (electron uptake) takes place on the cathode 8. The oxidation as electron output is performed at the anode 7.

The redox equations of the electrochemical processes are as follows:

### Cathode:

O₂+4H⁺+4e⁻-->>2H₂O

### Anode:

2H₂-->>4H⁺+4e⁻

### Summed Reaction Equation of Cathode and Anode:

2H₂+O₂-->>2H₂O

The difference in the normal potentials of the electrode pairs under standard conditions as reversible fuel cell voltage or neutral voltage of the unloaded fuel cell 2 is 1.23 V. This theoretical voltage of 1.23 V is not achieved in practice. At rest and at small currents, voltages above 1.0 V can be achieved and, in operation with larger currents, voltages between 0.5 V and 1.0 V are achieved. The series connection of several fuel cells 2, in particular a fuel cell unit 1 as a fuel cell stack 1 of several stacked fuel cells 2, has a higher voltage, which corresponds to the number of fuel cells 2 multiplied by the individual voltage of each fuel cell 2.

The fuel cell 2 also comprises a proton exchange membrane 5 (PEM), which is arranged between the anode 7 and the cathode 8. The anode 7 and cathode 8 are designed in a layer or disc shape. The PEM 5 functions as an electrolyte, catalyst carrier, and separating device for the reaction gases. The PEM 5 also functions as an electrical insulator and prevents an electrical short circuit between the anode 7 and cathode 8. In general, 12 μm to 150 μm thick, proton-conductive films made of perfluorinated and sulfonated polymers are used. The PEM 5 conducts the protons H⁺ and substantially blocks ions other than protons H⁺ so that charge transport can occur due to the permeability of PEM 5 for the protons H⁺. The PEM 5 is substantially impermeable to the reaction gases oxygen O₂ and hydrogen H₂, i.e. it blocks the flow of oxygen O₂ and hydrogen H₂ between a gas chamber 31 at the anode 7 with fuel hydrogen H₂ and the gas chamber 32 at the cathode 8 with air or Oxygen O₂ as oxidizing agents. The proton conductivity of the PEM 5 increases with increasing temperature and increasing water content.

On the two sides of the PEM 5, each facing the gas chambers 31, 32, the electrodes 7, 8 are located as the anode 7 and cathode 8. A unit consisting of the PEM 5 and the electrodes 7, 8 is referred to as a membrane electrode arrangement 6 (MEA). The electrodes 7, 8 are composed of an ionomer, for example Nafion®, platinum-containing carbon particles and additives. These electrodes 7, 8 comprising the ionomer are electrically conductive due to the carbon particles and also conduct the protons H⁺ and also act as a catalyst layer 30 due to the platinum-containing carbon particles. Membrane electrode assemblies 6 with these electrodes 7, 8 and the PEM 5 form membrane electrode assemblies 6 as CCM (catalyst coated membrane).

A gas diffusion layer 9 (GDL) is located on the anode 7 and cathode 8. The gas diffusion layer 9 at the anode 7 evenly distributes the fuel from channels 12 for fuel to the anode 7. The gas diffusion layer 9 on the cathode 8 evenly distributes the oxidizing agent from channels 13 for oxidizing agent onto the cathode 8. The GDL 9 also draws off reaction water in the opposite direction to the direction of flow of the reaction gases, i.e. in one direction each from the electrodes 7, 8 to the channels 12, 13. Furthermore, the GDL 9 keeps the PEM 5 moist and conducts the power.

A bipolar plate 10 lies atop the GDL 9. The electrically conductive bipolar plate 10 serves as a current collector, for draining water and for conducting the reaction gases as process fluids through the channel structures 29 and/or flow fields 29 and for dissipating the waste heat, which occurs in particular during the exothermic electrochemical reaction at the cathode 8. To dissipate the waste heat, channels 14 are incorporated into the bipolar plate 10 as a channel structure 29 for the passage of a liquid or gaseous coolant as a process fluid. The channel structure 29 on the gas chamber 31 for fuel is formed by channels 12. The channel structure 29 on the gas chamber 32 for oxidizing agents is formed by channels 13. For example, metal, conductive plastics, and composites or graphite are used as the material for the bipolar plates 10.

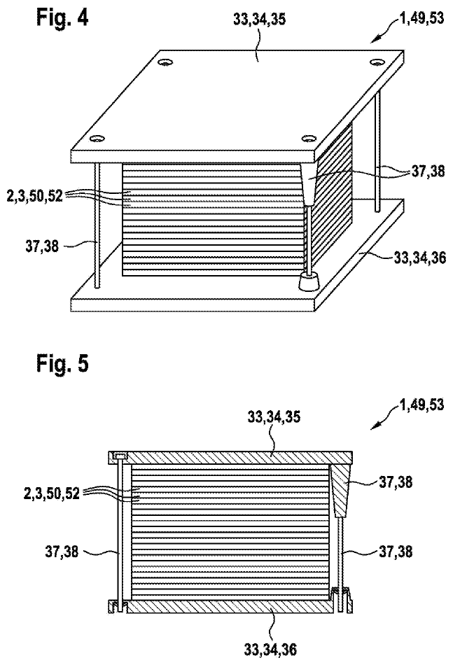

In a fuel cell unit 1 and/or a fuel cell stack 1 and/or a fuel cell stack 1, several fuel cells 2 are arranged so to as to be stacked in alignment (FIGS. 4 and 5). FIG. 1 shows an exploded view of two fuel cells 2 arranged in an aligned stack. Sealing gaskets 11 seal the gas chambers 31, 32 or channels 12, 13 in a fluid-tight manner. In a compressed gas reservoir 21 (FIG. 1), hydrogen H₂ is stored as a fuel at a pressure of, e.g., 350 bar to 700 bar. From the compressed gas reservoir 21, the fuel is conducted through a high pressure conduit 18 to a pressure reducer 20 in order to reduce the pressure of the fuel in a medium pressure conduit 17 of about 10 bar to 20 bar. From the medium pressure conduit 17, the fuel is conducted towards an injector 19. At the injector 19, the pressure of the fuel is reduced to an injection pressure of between 1 bar and 3 bar. From the injector 19, the fuel is supplied to a fuel supply conduit 16 (FIG. 1) and from the supply conduit 16 to the fuel channels 12 forming the channel structure 29 for fuel. As a result, the fuel passes through the gas chamber 31 for the fuel. The gas chamber 31 for the fuel is formed by the channels 12 and the GDL 9 at the anode 7. After passing through the channels 12, the fuel not consumed in the redox reaction at the anode 7 (and optionally water) are discharged from a controlled humidification means of the anode 7 via a discharge conduit 15 from the fuel cells 2.

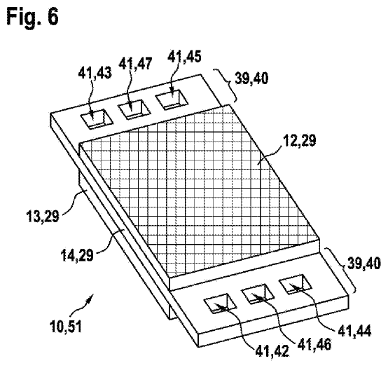

A gas conveying device 22, designed as, e.g., a blower 23 or a compressor 24, conveys air from the surroundings as an oxidizing agent into an oxidizing agent supply conduit 25. From the supply conduit 25, the air is supplied to the oxidizing agent channels 13, which form a channel structure 29 on the bipolar plates 10 for oxidizing agents such that the oxidizing agent passes through the gas chamber 32 for the oxidizing agent. The gas chamber 32 for the oxidizing agent is formed by the channels 13 and the GDL 9 on the cathode 8. After passing through the channels 13 or the gas chamber 32 for the oxidizing agent 32, the oxidizing agent not consumed on the cathode 8 and the reaction water resulting on the cathode 8 due to the electrochemical redox reaction are discharged from the fuel cells 2 through a discharge conduit 26. A supply conduit 27 is used to supply coolant into the channels 14 for coolant, and a discharge conduit 28 is used to discharge coolant conducted through the channels 14. The supply and discharge conduits 15, 16, 25, 26, 27, 28 are shown as separate conduits in FIG. 1 for reasons of simplification. At the end region in the vicinity of the channels 12, 13, 14, fluid openings 41 are formed in the stack of the fuel cell unit 1 on sealing plates 39 as an extension at the end region 40 of the bipolar plates 10 (FIG. 6) and membrane electrode arrangements 6 (not illustrated) lying on top of one another. The fuel cells 2 and the components of the fuel cells 2 are disk-shaped and span fictitious planes 59 that are essentially parallel to one another. The aligned fluid openings 41 and sealing gaskets (not shown) in a direction perpendicular to the fictitious planes 59 between the fluid openings 41 thus form a supply channel 42 for oxidizing agent, a discharge channel 43 for oxidizing agent, a supply channel 44 for fuel, a discharge channel 45 for fuel, a supply channel 46 for coolant and a discharge channel 47 for coolant. The supply and discharge conduits 15, 16, 25, 26, 27, 28 outside the stack of the fuel cell unit 1 are designed as process fluid conduits. The supply and discharge conduits 15, 16, 25, 26, 27, 28 outside the stack of the fuel cell unit 1 open into the supply and discharge channels 42, 43, 44, 45, 46, 47 inside the stack of the fuel cell unit 1. The fuel cell stack 1, together with the compressed gas reservoir 21 and the gas conveying device 22, form a fuel cell system 4.

In the fuel cell unit 1, the fuel cells 2 are arranged between two clamping elements 33 as clamping plates 34. A first clamping plate 35 rests on the first fuel cell 2 and a second clamping plate 36 rests on the last fuel cell 2. The fuel cell unit 1 comprises approximately 200 to 400 fuel cells 2, not all of which are shown in FIGS. 4 and 5 for graphic reasons. The clamping elements 33 apply a compressive force to the fuel cells 2, i.e. the first clamping plate 35 rests with a compressive force on the first fuel cell 2 and the second clamping plate 36 rests with a compressive force on the last fuel cell 2. The fuel cell stack 2 is thus braced to ensure tightness for the fuel, the oxidizing agent and the coolant, in particular due to the elastic sealing gaskets 11, and also to keep the electrical contact resistance within the fuel cell stack 1 as low as possible. To clamp the fuel cells 2 with the clamping elements 33, four connection devices 37 are designed on the fuel cell unit 1 as bolts 38, which are tensioned. The four bolts 38 are fixedly connected to the clamping plates 34.

FIG. 6 shows the bipolar plate 10 of the fuel cell 2. The bipolar plate 10 comprises the channels 12, 13 and 14 as three separate channel structures 29. The channels 12, 13 and 14 are not shown separately in FIG. 6, but merely simplified as a layer of a channel structure 29. The fluid openings 41 on the sealing plates 39 of the bipolar plates 10 and membrane electrode arrangements 6 (not illustrated) are stacked in alignment within the fuel cell unit 1, so that supply and discharge channels 42, 43, 44, 45, 46, 47 are formed. Sealing gaskets not shown are arranged between the sealing plates 39 for fluid-tight sealing of the supply and discharge channels 42, 43, 44, 45, 46, 47 formed by the fluid openings 41.

Since the bipolar plate 10 also separates the gas chamber 31 for fuel from the gas chamber 32 for oxidizing agent in a fluid-tight manner and also seals the channel 14 for coolant in a fluid-tight manner, the term separator plate 51 can also be selected for the bipolar plate 10 for the fluid-tight decomposition or separation of process fluids. This means that the term bipolar plate 10 also includes the term separator plate 51 and vice versa. The channels 12 for fuel, the channels 13 for oxidizing agent and the channels 14 for coolant of the fuel cell 2 are also formed on the electrochemical cell 52, but with a different function.

The fuel cell unit 1 can also be used and operated as an electrolysis cell unit 49, i.e. it forms a reversible fuel cell unit 1. In the following, some features are described which enable the fuel cell unit 1 to be operated as an electrolysis cell unit 49. A liquid electrolyte, namely highly diluted sulfuric acid with a concentration of approximately c (H₂SO₄)=1 mol/l, is used for electrolysis. A sufficient concentration of oxonium ions H₃0⁺ in the liquid electrolyte is necessary for electrolysis.

The following redox reactions take place during electrolysis:

### Cathode:

4H₃O⁺+4e⁻-->>2H₂+4H₂O

### Anode:

6H₂O-->>O₂+4H₃O⁺+4e⁻

### Summed Reaction Equation of Cathode and Anode:

2H₂O-->>2H₂+O₂

The polarity of the electrodes 7, 8 is reversed with electrolysis during operation as an electrolysis cell unit 49 (not shown) as during operation as a fuel cell unit 1, so that hydrogen H₂ is formed as a second substance at the cathodes in the channels 12 for fuel, through which the liquid electrolyte is passed, and the hydrogen H₂ is absorbed by the liquid electrolyte and transported in solution. Similarly, the liquid electrolyte is fed through the channels 13 for oxidizing agents and oxygen O₂ is formed as the first substance at the anodes in or at channels 13 for oxidizing agents. The fuel cells 2 of the fuel cell unit 1 function as electrolysis cells 50 during operation as electrolysis cell unit 49. The fuel cells 2 and electrolysis cells 50 thus form electrochemical cells 52. The oxygen O₂ formed is absorbed by the liquid electrolyte and transported in solution. The liquid electrolyte is stored in a storage reservoir 54. For reasons of simplification, FIG. 1 shows two storage reservoirs 54 of the fuel cell system 4, which also functions as an electrolysis cell system 48. A 3-way valve 55 on the supply conduit 16 for fuel is switched over during operation as an electrolysis cell unit 49, so that the liquid electrolyte is fed into the supply conduit 16 for fuel by a pump 56 from the storage reservoir 54 rather than fuel from the compressed gas reservoir 21. A 3-way valve 55 on the supply conduit 25 for oxidizing agent is switched over during operation as electrolysis cell unit 49, so that the liquid electrolyte is fed into the supply conduit 25 for oxidizing agent by the pump 56 from the storage reservoir 54 rather than oxidizing agent as air from the gas conveying device 22. The fuel cell unit 1, which also functions as an electrolysis cell unit 49, has optional modifications to the electrodes 7, 8 and the gas diffusion layer 9 compared to a fuel cell unit 1 that can only be operated as a fuel cell unit 1: for example, the gas diffusion layer 9 is not absorbent, so that the liquid electrolyte easily runs off completely, or the gas diffusion layer 9 is not formed, or the gas diffusion layer 9 is a structure on the bipolar plate 10.

A separator 57 for hydrogen is arranged on the discharge conduit 15 for fuel. The separator 57 separates the hydrogen from the electrolyte with hydrogen and the separated hydrogen is fed into the compressed gas reservoir 21 by a compressor not shown. The electrolyte drained from the separator 57 for hydrogen is then fed back to the storage reservoir 54 for the electrolyte via a conduit. The hydrogen separated at the separator 57 can be fed to the compressed gas storage tank 21 using a compressor not shown. A separator 58 for oxygen is arranged on the discharge conduit 26 for fuel. The separator 58 separates the oxygen from the electrolyte with oxygen and the separated oxygen is fed into a compressed gas reservoir for oxygen, not shown, using a compressor, not shown. The oxygen in the compressed gas reservoir for oxygen, which is not shown, can optionally be used for the operation of the fuel cell unit 1 by sliding the oxygen into the supply conduit 25 for oxidizing agent with a conduit, which is not shown, during operation as fuel cell unit 1. The electrolyte drained from the separator 58 for oxygen is then fed back to the storage reservoir 54 for the electrolyte via a conduit. The channels 12, 13 and the discharge and supply conduits 15, 16, 25, 26 are designed in such a way that after use as an electrolysis cell unit 49 and the pump 56 is switched off, the liquid electrolyte runs back completely into the storage reservoir 54 due to gravity. Optionally, after use as an electrolysis cell unit 49 and before use as a fuel cell unit 1, an inert gas is passed through the channels 12, 13 and the discharge and supply conduits 15, 16, 25, 26 to completely remove the liquid electrolyte before the gaseous fuel and oxidizing agent are passed through. The fuel cells 2 and the electrolysis cells 2 thus form electrochemical cells 52. The fuel cell unit 1 and the electrolysis cell unit 49 thus form an electrochemical cell unit 53. The channel 12 for fuel and the channel for oxidizing agent thus form channels 12, 13 for the passage of the liquid electrolyte during operation as an electrolysis cell unit 49 and this applies analogously to the supply and discharge conduits 15, 16, 25, 26. For process-related reasons, an electrolysis cell unit 49 does not normally require channels 14 for the passage of coolant. In an electrochemical cell unit 49, the channels 12 for fuel also form channels 12 for passing fuel and/or electrolytes and the channels 13 for oxidizing agents also form channels 13 for passing fuel and/or electrolytes.

In another exemplary embodiment, not shown, the fuel cell unit 1 is designed as an alkaline fuel cell unit 1. Potassium hydroxide solution is used as a mobile electrolyte. The fuel cells 2 are arranged in a stack. A monopolar cell structure or a bipolar cell structure can be formed. The potassium hydroxide solution circulates between an anode and cathode and removes reaction water, heat and impurities (carbonates, dissolved gases). The fuel cell unit 1 can also be operated as a reversible fuel cell unit 1, i.e. as an electrolysis cell unit 49.

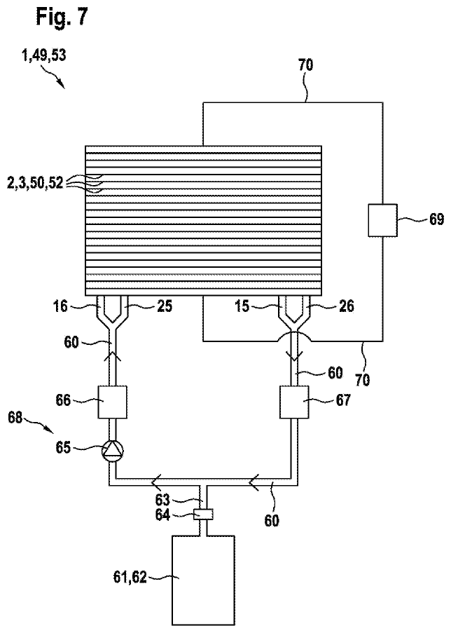

In FIG. 7, the electrochemical cell unit 53, in particular as the fuel cell unit 1, is illustrated with a device 68 for carrying out a method for conditioning the electrochemical cell unit 53. The electrochemical cell unit 53 has the supply line 16 for fuel and the supply line 25 for oxidizing agent. Furthermore, the electrochemical cell unit 53 has the discharge line 15 for fuel and the discharge line 26 for oxidizing agent. Instead of the discharge line 15 for fuel, the supply line 16 for fuel, the supply line 25 for oxidizing agent and the discharge line 26 for oxidizing agent, the electrochemical cell unit 53 can also be provided with only four corresponding openings for discharging and supplying fuel and oxidizing agent. The supply line 16 for fuel or a corresponding opening and the supply line 25 for oxidizing agent or a corresponding opening lead into a common hydrogen line 60. The discharge line 15 for fuel or a corresponding opening and the discharge line 26 for oxidizing agent or a corresponding opening lead into a common hydrogen line 60. The hydrogen line 60 is designed in such a way that hydrogen as a conditioning fluid for conditioning the electrochemical cell unit 53 can be passed together in a circuit through the channels 12 for fuel and the channels 13 for the oxidizing agent of the fuel cell unit 1.

A pump 65 for pumping the hydrogen in the circuit is arranged in the hydrogen line 60. A humidification device 66 is used to humidify the hydrogen to a predetermined setpoint value of relative or absolute humidity before it is fed into the channels 12 for fuel and into the channels 13 for the oxidizing agent. Furthermore, a dehumidifying device 67 is installed in the hydrogen line 60. In the dehumidifying device 67, excess moisture in the hydrogen in the hydrogen line 60 is separated. A hydrogen supply 61 in the form of a pressurized hydrogen container 62 is connected to the hydrogen line 60 via a dosing line 63 and a valve 64. To start the method for conditioning the electrochemical cell unit 53, the valve 64 is opened, thereby substantially completely filling the hydrogen line 60 and the channels 12 and/or gas chambers 31 for fuel and the channels 13 and/or gas chambers 32 for oxidizing agent with hydrogen, so that the amount of hydrogen in the channels 12 for fuel and the channels 13 for oxidizing agent and in the hydrogen line 60 is greater than 99%, in particular the hydrogen line 60 and the channels 12 for fuel and the channels 13 for oxidizing agent are completely filled with pure hydrogen. For this purpose, additional corresponding valves, not shown, are arranged in the hydrogen line 60 so that excess gas, in particular air after production, in the hydrogen line 60 and the channels 12 for fuel and the channels 13 for oxidizing agent can be discharged into the surroundings during filling with hydrogen until these are completely and exclusively filled with hydrogen.

The device 68 for carrying out the method also comprises a direct current source 69 and power lines 70. A corresponding direct current is applied to the anodes 7 and cathodes 8 of the fuel cells 2 by means of the direct current source 69. A polarity reversal can also be carried out with a changeover switch not shown, so that anodes 7 before the polarity reversal form cathodes 8 after the polarity reversal and cathodes 8 before the polarity reversal form anodes 7 after the polarity reversal and vice versa.

Due to this application of direct current or direct voltage to the anodes 7 and cathodes 8 and the filling of the channels 12 for fuel and the channels 13 for oxidizing agent with hydrogen, i.e. the continuous passage of hydrogen through the channels 12 for fuel and the channels 13 for oxidizing agent, the subsequent chemical reactions take place during the conditioning method:

### Anode:

H₂-->>2H⁺+2e⁻

### Cathode:

2H⁺+2e⁻-->>H₂

Hydrogen is thus oxidized to protons H⁺ at the anode 7, releasing electrons to the anodes 7, and protons H⁺ are reduced to hydrogen at the cathode 8, accepting electrons from the cathode. The electrons are conducted from the anodes 7 to the cathodes 8. The protons H⁺ generated at the anode 7 migrate through the proton exchange membrane 5 to the cathode 8, where they are reduced to hydrogen. There is therefore a material conversion in which the reactant hydrogen corresponds to the product hydrogen. This process is generally carried out at a temperature higher than room temperature or slightly higher, i.e. in a temperature range between 20° C. and 30° C., for example. The material conversion or reaction conversion with the hydrogen conditioning fluid enables more effective removal of oxide layers and impurities, particularly on the electrodes 7, 8 and the catalyst layers 30. Due to the possibility of reversing the polarity, the anodes 7 and cathodes 8 can be treated identically, i.e. the oxide layers and impurities can be removed in the same way. The humidification of components of the fuel cell unit 1, in particular the proton exchange membrane 5, is carried out by means of the humidification device 66 and the dehumidification device 67 by humidifying the hydrogen, which is passed through the channels 12 for fuel and the channels 13 for oxidizing agent, sufficiently so that the proton exchange membrane 5 has sufficient humidification, so that the proportion of hydrogen in the conditioning fluid is slightly less than 100%. In the conditioning fluid, for example, the mass fraction of hydrogen is 98% and the mass fraction of water and/or water vapor is 2%. The conditioning fluid is thus formed by the hydrogen and water and/or water vapor. The water used for humidification is degassed before being used for the humidification device 66, e.g. by means of ultrasound, so that no gases are dissolved in the water used for humidification. Essentially no hydrogen is consumed during the method because the oxide layers are only present on the components of the fuel cell unit 1 with a very small, atomic thickness and thus a negligible consumption of hydrogen occurs for the reduction of oxides, for example platinum oxide to platinum, by means of the reducing agent hydrogen.

The method for conditioning the electrochemical cell unit 53 can be modified in a further, not shown exemplary embodiment in such a way that the channels 12 for fuel are flooded with water, in particular water is passed through the channels 12 for fuel in a circuit. The water is degassed before being used in the channels 12 for fuel, in particular by means of ultrasound. The hydrogen is passed through the channels 13 for oxidizing agents in the same way as in the first exemplary embodiment. In this second exemplary embodiment, the polarity of the anode 7 and cathode 8 is not reversed. Due to the flooding of the channels 12 for fuel with water, water is present at the anodes 7 and this is split into hydrogen in an electrolysis at the anode 7, so that hydrogen is also present at the anode 7 in the second exemplary embodiment due to the formation from water and subsequently the same processes take place as in the first exemplary embodiment, i.e. that the hydrogen is oxidized to protons at the anode 7 and these protons migrate through the proton exchange membrane 5 in an analogous manner.

Overall, the method according to the invention for conditioning the electrochemical cell unit 53 and the electrochemical cell unit 53 according to the invention have significant advantages. In the continuous method, hydrogen is continuously passed through the channels 13 for oxidizing agent for a longer period of at least 5 minutes and hydrogen is continuously passed through the channels 12 for fuel or the channels 12 for fuel are continuously flooded with water, in particular water is passed through the channels 12 for fuel. This method is carried out continuously, i.e. without interruption. There is essentially no consumption of hydrogen because the hydrogen is circulated through the electrochemical cell unit 53. This makes the method cost-effective to carry out. For the continuous conditioning of the electrochemical cell unit 53, a method duration of approximately 20 to 60 minutes is necessary, so that a large number of electrochemical cell units 53 can be conditioned in a short time. A large stock of electrochemical cell units 53 during conditioning can thus be avoided. The device 68 has a simple design because only one type of gas, namely hydrogen, is required for conditioning. In general, no temperature control of the electrochemical cell units 53 is necessary during the performance of the method, because the method can be carried out at room temperature in the range between 15° C. and 25° C. No water is produced in the electrochemical cell unit 53 during the performance of the method, so that no excess water needs to be removed during the performance of the method. After conditioning the electrochemical cell unit 53, the channels 12 for fuel and the channels 13 for oxidizing agent are filled with hydrogen, so that no conversion of electrochemical energy into electrical energy can be carried out by the fuel cell unit 1 and thus there is no risk of electric shocks to the fuel cell unit 1 after the method has been carried out.

1. A method for conditioning an electrochemical cell unit (53) before putting the electrochemical cell unit (53) into operation for converting electrochemical energy into electrical energy as a fuel cell unit (1) and/or for converting electrical energy into electrochemical energy as an electrolytic cell unit (49) having stacked electrochemical cells (52) and channels (12) for conducting a fuel and/or an electrolyte and channels (13) for conducting an oxidizing agent and/or an electrolyte being formed in the electrochemical cell unit (53), the method having the steps of:
providing a conditioning fluid;
conducting the conditioning fluid through the channels (12) for fuel and/or electrolytes and/or conducting the conditioning fluid through the channels (13) for oxidizing agents and/or electrolytes,
wherein,
during at least 50% of a duration of the method for conditioning the electrochemical cell unit (53), hydrogen as the conditioning fluid is passed through the channels (13) for oxidizing agents and/or electrolytes.

2. The method according to claim 1,
wherein
hydrogen is passed through the channels (13) for oxidant and/or electrolyte during at least 70%, 80% or 90% of the duration of the method for conditioning the electrochemical cell unit (53).

3. The method according to claim 1,
wherein
hydrogen is passed through the channels (13) for oxidant and/or electrolyte during an entire duration of the method for conditioning the electrochemical cell unit (53).

4. The method according to claim 1,
wherein
during the passage of hydrogen through the channels (13) for oxidant and/or electrolyte, anodes (7) and cathodes (8) are connected to a direct current source (69), so that a direct voltage difference is formed between the anodes (7) and cathodes (8).

5. The method according to claim 1,
wherein
during the passage of hydrogen through the channels (13) for oxidant and/or electrolyte, protons migrate through proton exchange membranes (5) in a direction from anodes (7) to cathodes (8).

6. The method according to claim 1,
wherein
while hydrogen is passed through the channels (13) for oxidant and/or electrolyte, hydrogen is simultaneously passed through the channels (12) for fuel and/or electrolyte as conditioning fluid.

7. The method according to claim 6,
wherein
during the passage of hydrogen through the channels (12) for fuel and/or electrolyte, protons are formed from the hydrogen at anodes (7) by reducing the hydrogen to protons while releasing electrons and the protons migrate through proton exchange membranes (5) in one direction from the anodes (7) to cathodes (8).

8. The method according to claim 1,
wherein
an amount and/or mass fraction of hydrogen in the conditioning fluid which is passed through the channels (13) for oxidant and/or electrolyte and/or through the channels (12) for fuel and/or electrolyte is at least 80%, 90%, 95%, 98% or 99%.

9. The method according to claim 1,
wherein
during the passage of hydrogen through the channels (13) for oxidant and/or electrolyte, the channels (12) for fuel and/or electrolyte are simultaneously flooded with water as conditioning fluid.

10. The method according to claim 9,
wherein
during the flooding of the channels (12) for fuel and/or electrolytes with water, protons are formed from the water at anodes (7) and the protons migrate through proton exchange membranes (5) in one direction from the anodes (7) to cathodes (8).

11. The method according to claim 1,
wherein
during the passage of hydrogen through the channels (13) for oxidizing agents and/or electrolytes, hydrogen is formed at cathodes (8) by reducing protons that have migrated through a proton exchange membrane (5) to hydrogen by accepting electrons from cathodes (8).

12. The method according to claim 1,
wherein
the hydrogen is passed through the channels (13) and/or gas chambers (32) for oxidant and/or electrolyte and/or through the channels (12) and/or gas chambers (31) for fuel and/or electrolyte with a circuit.

13. The method according to claim 1,
wherein
the hydrogen is moistened and/or enriched with water and/or water vapor before being introduced into the channels (13) for oxidant and/or electrolyte and/or into the channels (12) for fuel and/or electrolyte.

14. The method according to claim 1,
wherein
the passing of hydrogen through the channels (13) for oxidant and/or electrolyte is carried out during a period of time between 5 min and 3 h.

15. An electrochemical cell unit (53) for converting electrochemical energy into electrical energy as a fuel cell unit (2) and/or for converting electrical energy into electrochemical energy as an electrolysis cell unit (49), comprising
stacked electrochemical cells (52) and the electrochemical cells (52) each comprise stacked layered components (5, 6, 7, 8, 9, 10, 51), and
the components (5, 6, 7, 8, 9, 10, 51) of the electrochemical cells (52) are proton exchange membranes (5), anodes (7), cathodes (8), gas diffusion layers (9) and bipolar plates (10, 51),
wherein
a method according to claim 1 can be carried out with the electrochemical cell unit (53).

16. The method according to claim 12, wherein the circuit is a common circuit.

17. The method according to claim 14, wherein the passing of hydrogen through the channels (13) for oxidant and/or electrolyte is carried out during a period of time between 10 min and 2 h.

18. The method according to claim 14, wherein the passing of hydrogen through the channels (13) for oxidant and/or electrolyte is carried out continuously.
